(19) United States
(12) Patent Application Publication
(10) Pub. No.: US 2015/0129111 A1
(43) Pub. Date: May 14, 2015

(54) Stabilization Device, Stabilization Method and Method For Producing Fiber Composite Components

(71) Applicant: Airbus Defence and Space GmbH, Ottobrunn (DE)

(72) Inventors: Bettina AROLD, Stade (DE); Ulf Henning NEUMANN, Hamburg (DE); Hermann SEEFRIED, Birkhausen (DE)

(21) Appl. No.: 14/540,626

(22) Filed: Nov. 13, 2014

(30) Foreign Application Priority Data
Nov. 14, 2013 (EP) 13005353.1

(51) Int. Cl. B29C 65/08; B29C 65/00

(52) U.S. Cl. CPC B29C 65/08; B29C 65/088; B29C 66/9241; B29K 2105/108
USPC 156/73.1; 156/580.1; 156/580.2

(57) ABSTRACT

A stabilization device includes a molding tool onto which at least one fiber layer having a binder material is placed. The device also includes a consolidation device having sonotrode that applies ultrasonic energy to the fiber layer. The molding tool positions the fiber layer in a predetermined position relative to the sonotrode.

### CROSS-REFERENCE TO RELATED APPLICATIONS

The present application claims priority under 35 U.S.C. §119 to European application 13005353.1, filed Nov. 14, 2013, the entire disclosure of which is herein expressly incorporated by reference.

### BACKGROUND AND SUMMARY OF THE INVENTION

Exemplary embodiments of the invention relate to a stabilization device for stabilizing a fiber layer, a corresponding stabilization method, and a method for producing fiber composite components having an open structure in which the stabilization method is implemented.

It is known to place fiber bundles in a desired three-dimensional form on a molding tool. For example, in particular in braiding processes, individual fibers are placed on a so-called braiding core as a molding tool in order to form a closed contour. As long as the fibers are positioned on the braiding core they form a stable contour, for example, the contour of a component to be produced; however, they are not so firmly connected to one another that they can be simply unmolded or removed from the braiding core without losing the contour that is produced by the braiding process. The same is also true of other methods in which fiber bundles have been attached or fixed in a three-dimensional shape on a molding tool. Therefore, the fiber layers that are produced are stabilized.

It is known, for example, to carry out an oven process while the fibers are still positioned on the molding tool. Alternatively, manual processes such as the application of an iron may also be used to thermally stabilize the braided layers.

US patent document US 2012/0085480 A1 discloses consolidating flat fabrics or non-crimped fabrics made of fibrous materials to a preform by applying ultrasound and pressure to the fabrics.

Known stabilization methods, such as the oven process or manual methods, either are discontinuous and therefore not automatable, or result in long process times.

Exemplary embodiments of the invention therefore are directed to a device and a method for stabilizing fiber layers that have been placed on a molding tool, which can be carried out continuously and in an automated fashion.

A stabilization device for stabilizing at least one fiber layer that is formed on a molding tool and has a binder material comprises a consolidation device having at least one sonotrode for applying ultrasonic energy to the fiber layer, and a molding tool for positioning the fiber layer in a predetermined position relative to the sonotrode.

When ultrasonic energy is applied to the fibers by means of the sonotrode, the fibers begin to vibrate, resulting in a rapid heating of the fiber layer. The binder material that is present in or on the fiber layer is particularly a thermoplastic binder material, which is activated by the resulting heat, thereby stabilizing the fiber layer on the molding tool.

The molding tool is preferably designed such that it can position the fiber layer in a predetermined position relative to the sonotrode, thereby enabling an automatable stabilization method, which can also be carried out continuously, for example up to the end of a braiding process in which a component contour is produced.

Alternatively, however, the sonotrode can also be positionable relative to the molding tool.

The molding tool is preferably made of steel, aluminum, wood or CFRP, and the fiber layer advantageously comprises carbon fibers, aramid fibers and/or glass fibers.

In one advantageous embodiment, the molding tool is a braiding core. However, molds for non-crimped fabrics, drapings, lap layers and fabrics made of fiber bundles may also be used.

With thermal stabilization, it is possible not only to thermally stabilize flat textile structures such as fabrics or non-crimped fabrics (cf. US patent document US 2012/0085480 A1) in the known manner, but also to thermally stabilize three-dimensional coherent contours before they are unmolded from the molding base body, in particular from a braiding core, for example.

Advantageously, it is possible not only to stabilize individual fiber layers, but also to stabilize a plurality of overbraided fiber layers relative to one another, for example.

The consolidation device preferably comprises a pressure application device for applying pressure to the fiber layer. It is particularly preferable for pressure to be applied to the fiber layer at the same time that ultrasonic energy is applied. In this manner, in addition to stabilizing the fibers, compacting can also be achieved, so that the final thickness of the resulting preform is advantageously similar to what is desired in the subsequent component.

The pressure application device advantageously comprises the molding tool that holds the fiber layer as a pressure base and the sonotrode as pressure tool. The molding tool therefore advantageously acts as an anvil, so that, in contrast to known compacting methods, such as those disclosed in US patent document US 2012/0085480 A1, for example, an external anvil can be dispensed with. When the sonotrode is further advantageously used as the pressure tool, that is, as the element that applies pressure to the fiber layer to achieve compacting, an external pressure application element can also advantageously be dispensed with.

Preferably, pressure and ultrasound can be applied simultaneously with positioning of the fiber layer relative to the sonotrode. This preferably facilitates an automated configuration and advantageously contributes to the continuous stabilization and compacting of the fibers.

The pressure application device preferably has a pressure control device that allows the sonotrode to be pressed in a defined manner against the fiber layer. In particular, the pressure control device is formed with proportional valves. The proportional valves advantageously enable the sonotrode to be pressed pneumatically, for example, against the braided layer. However, any known and suitable methods and devices for pressing the sonotrode against the fiber layer may be used.

Thus, it is advantageously possible to apply a constant fusing force to the fiber layer or fiber layers, in order to enable a preferably continuous stabilization and compacting of the fibers. By applying pressure to a plurality of fiber layers, these layers are advantageously fused to one another, resulting in a preferred preform for use in producing a fiber composite component.

A feed device for moving the molding tool and the sonotrode relative to one another is advantageously provided. Particularly preferably, said device is designed to move the molding tool continuously relative to the sonotrode.

Alternatively, however, the sonotrode can also be moved relative to a stationary molding tool.

Advantageously, a movement of molding tool and sonotrode relative to one another is achieved.

A continuous consolidation and compacting of the fiber layer or fiber layers can be advantageously achieved thereby; moreover, the process can be carried out in an automated fashion.

A cooling device for cooling the sonotrode is preferably provided, so that the binder material, which is activated by the sonotrode, can advantageously be rapidly cooled and solidified.

In a particularly preferred embodiment, the sonotrode is mounted so as to float, allowing it to adjust its position relative to a surface structure of the fiber layer. This allows preferably flexible fiber layer geometries to be processed, since the sonotrode, rather than being spatially fixed in relation to the molding tool, is flexibly mounted, allowing the sonotrode to advantageously traverse different three-dimensional structures.

The sonotrode preferably has a low-friction coating at least on the sonotrode surface that is placed in contact with the fiber layer. Alternatively or additionally, a buffer film feed device may also be provided, which guides a buffer film between fiber layer and sonotrode. In this manner, surface damage or misalignment of the fibers during contact with the sonotrode can advantageously be avoided.

At least one radial sonotrode is preferably provided for encompassing one side and at least one edge region of the molding tool. This allows continuous solidification in the edge regions of the fiber layer to be advantageously achieved.

Sonotrodes are preferably arranged in pairs on opposite sides of the molding tool; in particular, a plurality of pairs of sonotrodes are arranged offset from one another around the molding tool, advantageously allowing a plurality of opposing regions of the molding tool to be consolidated and compacted at the same time.

A control device for controlling the pressure control device and/or the feed device and/or the sonotrode is preferably provided. In this manner, a fully automated control of the stabilizing and compacting process can preferably be achieved.

The control device is advantageously designed to control the ultrasonic amplitude of the ultrasound emitted by the sonotrode, the rate of feed of the molding tool and the welding force, or the pressing force, which is exerted by the sonotrode onto the fiber layer.

A stabilization method for stabilizing at least one fiber layer placed on a molding tool and having a binder material comprises the following steps:

a) preparing a stabilization device comprising at least one sonotrode and one molding tool that holds the fiber layer;

b) moving the molding tool relative to the sonotrode;

c) applying ultrasonic energy to the fiber layer.

The molding tool is preferably moved at a constant feed rate.

Advantageously, the sonotrode is pressed against the fiber layer at the same time that ultrasonic energy is applied to the fiber layer to the fiber layer, thereby advantageously compacting the fiber layer. Pressure can advantageously be applied pneumatically; however any known methods that are suitable for pressing the sonotrode against the fiber layer may be used.

Further advantageously, before the sonotrode is pressed against the fiber layer, the sonotrode is provided with a low-friction coating. Alternatively or additionally, a buffer film may also be inserted between sonotrode and fiber layer to advantageously protect the still dry fibers against damage and misalignment.

The sonotrode is preferably cooled.

A method for producing fiber composite components that have an open structure comprises the following steps:

d) forming at least one fiber layer on a molding tool;

e) providing binder material in and/or on the fiber layer;

f) implementing the above-described stabilization method;

g) unmolding the consolidated fiber layer, in particular cutting said layer away from the mold.

A plurality of fiber layers are preferably formed in step d), in particular by braiding, wrapping, laying, draping or weaving fibers onto the molding tool and/or by applying reinforcement patches to a braided fiber layer and/or by applying or depositing a fiber layer and/or a lap layer onto the braided fiber layer.

The binder material is preferably provided interlaminarly on the fibers that form the fiber layer. Alternatively or additionally, however, the binder material may also be applied to the fiber layer during formation of the fiber layer.

### BRIEF DESCRIPTION OF THE DRAWING FIGURES

In the following, embodiment examples of the invention will be specified in greater detail, in reference to the attached set of drawings. The drawings show:

FIG. 1 a first embodiment of a stabilization device having a fiber layer that is placed on a braiding core as a molding tool, and having a plurality of sonotrodes;

FIG. 2 a cross-section of the stabilization device of FIG. 1;

FIG. 3 the stabilization device of FIG. 1 with a buffer film feed device;

FIG. 4 a second embodiment of a stabilization device, having a radial sonotrode;

FIG. 5 a third embodiment of a stabilization device having a robot as the feed device for a sonotrode;

FIG. 6 a first view of a fiber composite component located on a molding tool;

FIG. 7 the fiber composite component of FIG. 6, unmolded and lying adjacent to the molding tool;

FIG. 8 a view of the exterior of the fiber composite component of FIGS. 6 and 7;

FIG. 9 a view of the interior of the fiber composite component of FIGS. 6 to 8; and

FIG. 10 a cross-sectional view of the fiber composite component of FIGS. 6 to 9.

### DETAILED DESCRIPTION

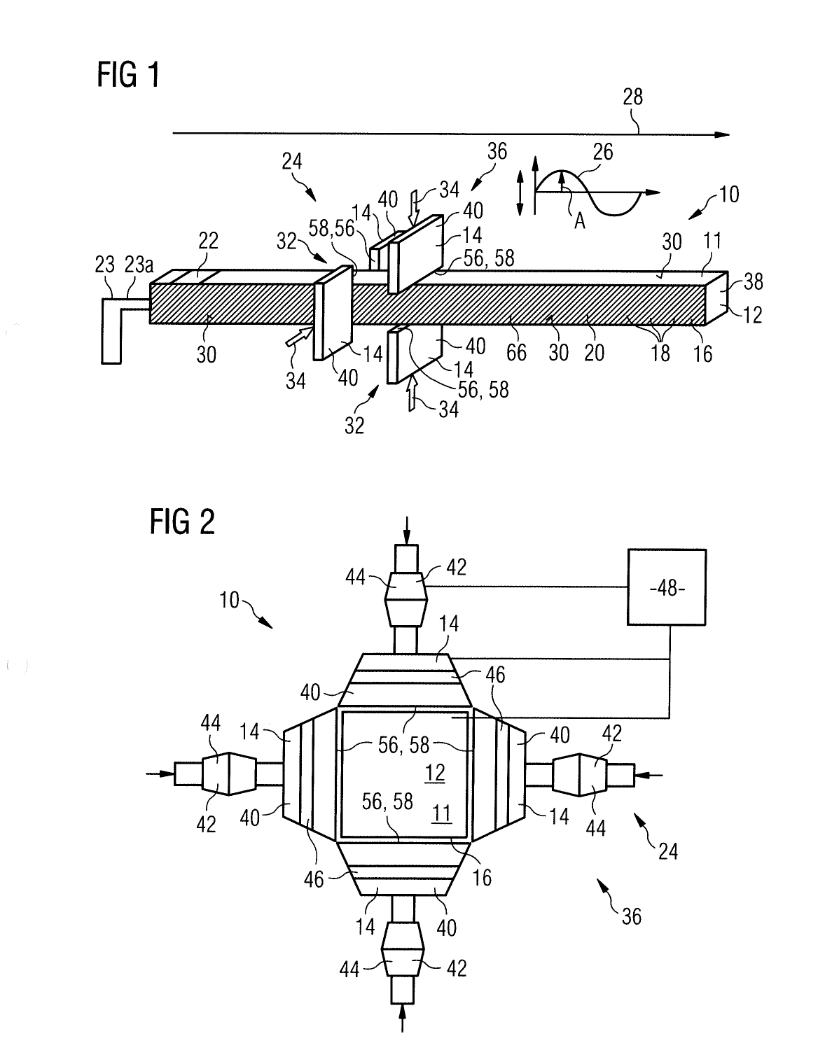

FIG. 1 shows a first embodiment example of a stabilization device 10, which comprises a molding tool 12, e.g. in the form of a braiding core 11, and a plurality of sonotrodes 14. A fiber layer 16 is applied to molding tool 12, the layer having been formed, for example, by depositing individual fibers 18 or fiber mats or a textile woven fabric and by additionally applying binder material 20. In particular, fiber layer 16 is applied by braiding fibers 18 onto braiding core 11.

A reinforcement patch 22 is further arranged on fiber layer 16, to reinforce fiber layer 16 in this region.

Molding tool 12 is designed for positioning fiber layer 16 located thereon in a predefined position relative to sonotrodes 14. For this purpose, molding tool 12 is guided, for example by a robot 23 as feed device 23a. Alternatively, sonotrodes 14 may be guided over a stationary molding tool 12 by means of a robot 23.

Sonotrodes 14 form a consolidation device 24 and apply ultrasonic energy to fiber layer 16. The energy is represented by the oscillation 26, which in the present embodiment example has a frequency of 20-35 kHz, by way of example, and an amplitude of 16-22 μm, by way of example. The displacement of fiber layer 16 by means of molding tool 12 is indicated by arrow 28.

Sonotrodes 14 are arranged parallel to side faces 30 of molding tool 12, with two sonotrodes being located on each of the opposing side faces 30 of molding tool 12, forming a pair 32 of sonotrodes 14. In the present example, successive pairs 32 are arranged offset 90° relative to one another, to allow ultrasound to be applied to both upper and lower side faces 30.

As indicated by arrow 34, sonotrodes 14 are also pressed against side faces 30 of molding tool 12, in order to additionally compact fiber layer 16 by the application of pressure.

FIG. 2 shows a cross-sectional view of stabilization device 10 of FIG. 1;

Sonotrodes 14, together with molding tool 12, form a pressure application device 36. Molding tool 12 acts as a pressure base 38, that is, as a counter bearing, in the form of an anvil, to the pressure that is applied, while sonotrodes 14 are pressed as pressure tools 40 against fiber layer 16. To allow sonotrodes 14 to be advantageously pressed uniformly and in a defined manner against fiber layer 16, a pressure control device 42 is provided, which has proportional valves 44. Compressed air can then be introduced in a defined manner via proportional valves 44, allowing sonotrodes 14 to be pneumatically pressed in a controlled and defined manner against fiber layer 16. However, other methods and/or devices that will enable sonotrodes 14 to be pressed in a controlled manner against fiber layer 16 may also be used.

When sonotrodes 14 are pressed against fiber layer 16 at the same time that ultrasonic energy is applied to fiber layer 16, binder material 20, which is present in or on fiber layer 16, is activated, in particular heated, thereby binding the individual fibers 18 to one another, stabilizing them in their position on molding tool 12. The pressure from sonotrodes 14 results at the same time in a compacting of fiber layer 16, bringing the layer as close as possible to the desired final geometry. To solidify binder material 20 as quickly as possible following activation, thereby stabilizing fibers 18, sonotrodes 14 have a cooling device 46, which enables a simultaneous cooling of binder material 20 when fiber layer 16 comes into contact with sonotrodes 14.

Fiber layer 16 is brought into a predefined position relative to sonotrodes 14 over molding tool 12, in particular by moving molding tool 12. To enable the fully automated consolidation, that is, stabilization and compacting, of fiber layer 16, a control device 48 is provided, which controls the displacement of molding tool 12, the application of ultrasound via sonotrodes 14, and the pressing of sonotrodes 14 against fiber layer 16.

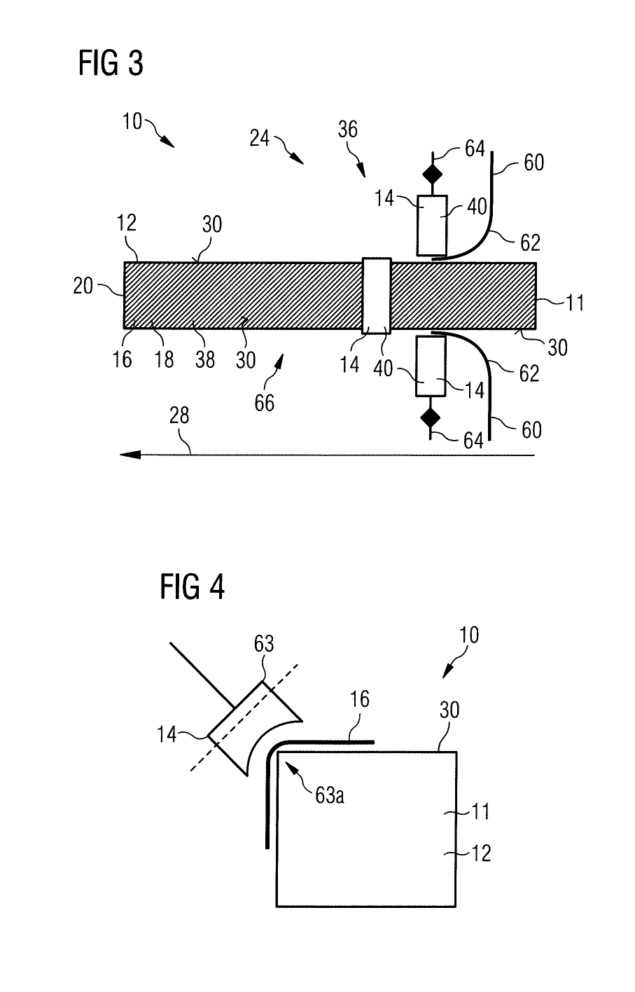

FIG. 3 shows stabilization device 10, in which molding tool 12 is guided along continuously between sonotrodes 14, and in which the method is controlled, fully automated, by control device 48.

Sonotrodes 14 shown in FIG. 1 and FIG. 2 have low-friction coatings 56, in particular on sonotrode surfaces 58, which come in contact with fiber layer 16.

FIG. 3 alternatively shows a buffer film feed device 60, which guides a buffer film 62 between fiber layer 16 and sonotrodes 14 to be pressed against said layer. Fiber layer 16 is protected both by low-friction coating 56 and by buffer film 62 against damage that might occur as sonotrodes 14 are pressed against fiber layer 16.

FIG. 4 shows a second embodiment of a stabilization device 10, in which a radial sonotrode 63 is provided as sonotrodes 14, which radial sonotrode is not arranged on a side face 30 of molding tool 12, and instead encompasses an edge region 63a of molding tool 12. With such a sonotrode 14 stabilization and consolidation can be achieved not only in side face region 30 over molding tool 12, but particularly also in edge region 63a of molding tool 12. Radial sonotrode 63 preferably rotates around molding tool 12.

Sonotrodes 14 in FIGS. 1, 2 and 4 are mounted fixed, that is immovably, whereas sonotrodes 14 in FIG. 3 have a flexible mount 64. This allows sonotrodes 14 to independently adapt to the contour or surface structure 66 of fiber layer 16 during the stabilization process.

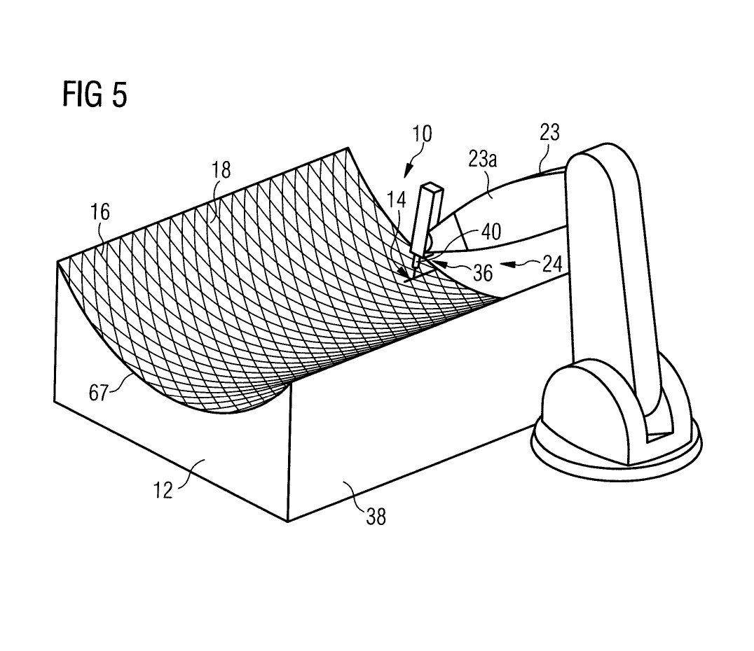

FIG. 5 shows a third embodiment of a stabilization device 10, in which molding tool 12 is formed by a bearing surface 67 for fiber layer 16. In this case, sonotrodes 14 are guided by a robot 23, while molding tool 12 is stationary.

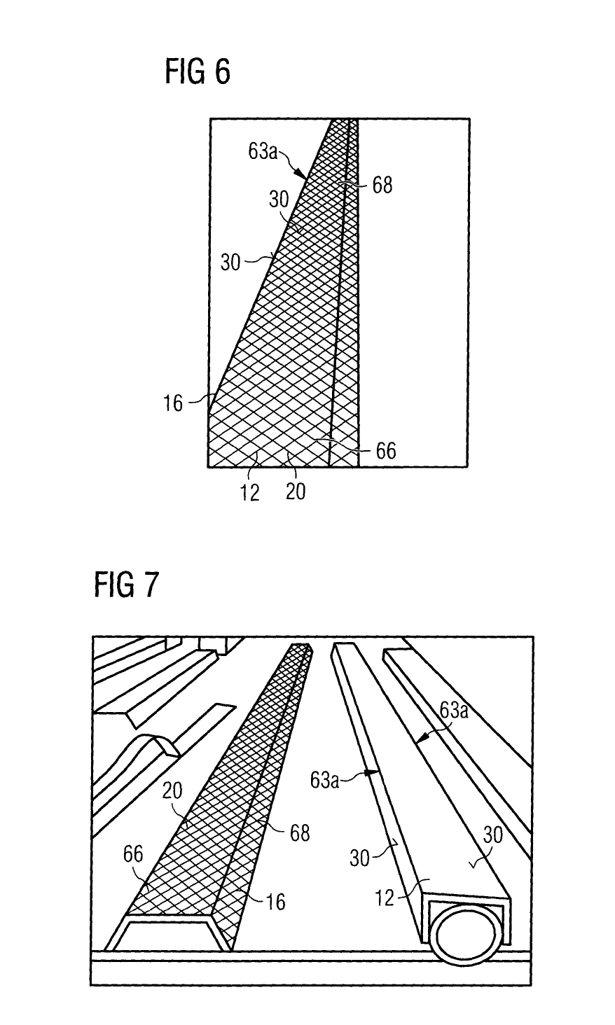

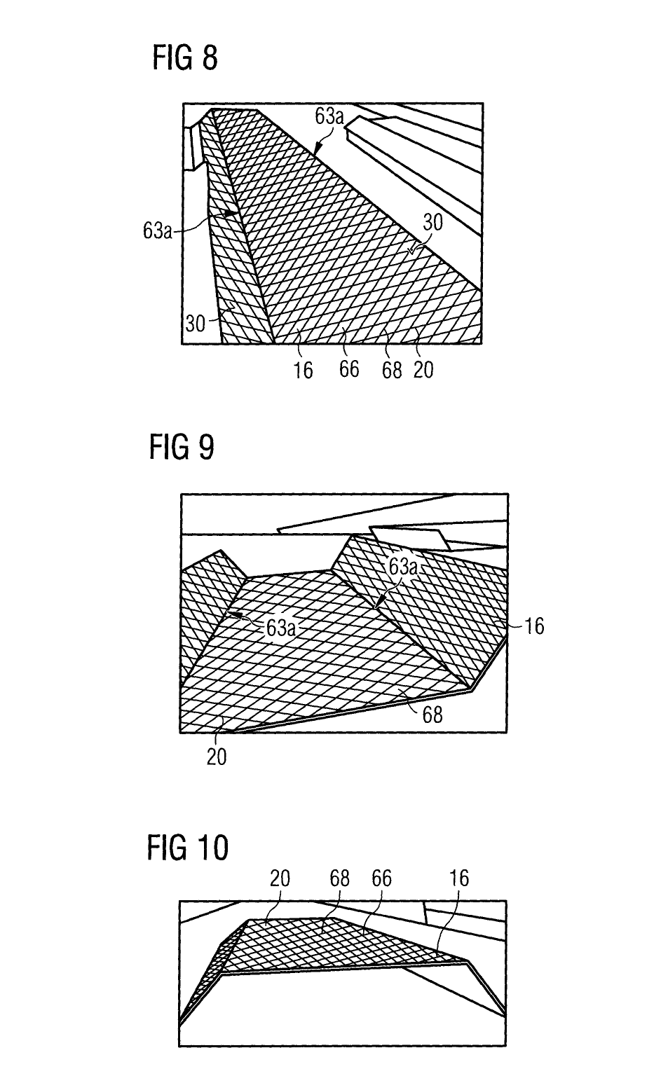

FIGS. 6 to 10 show a fiber composite component 68 which has been formed using the described stabilization device 10, following the unmolding thereof from molding tool 12. As is clear from FIGS. 6 and 7, fiber composite component 68 has been stabilized, consolidated and compacted during the stabilization process such that it can be easily cut away from molding tool 12 without fibers 18 losing their predetermined position in fiber composite component 68. FIG. 8 to FIG. 10 each show detailed views of the produced fiber composite component 68, wherein FIG. 8 shows a view of the exterior of fiber composite component 68, FIG. 9 shows a view of the interior of fiber composite component 68, and FIG. 10 shows a cross-section of fiber composite component 68 with a view of the thickness range thereof.

During a circular braiding process, for example, individual fibers 18 are placed on a molding tool 12—which can be, for example, a so-called braiding core 11 or other molding tools, e.g. shells or molds having molding surfaces—and form a closed contour. If this process will result in dry components 68 having a non-closed contour, i.e. if components 68 will be cut away in the non-fused state, it is preferable for braided layers or otherwise produced fiber layers 16 to be thermally stabilized under pressure if at all possible. If the layers 16 are not stabilized, they will disintegrate again into individual fibers 18 when they are cut away.

As is known, this process is carried out by means of discontinuous or manual processes (vacuum bag in oven; iron). When additional materials (e.g. non-woven materials, powders) are introduced, it is also preferable for the stabilizing and compacting cycle to be implemented in order to keep the bulk factor as low as possible (i.e. the final thickness of the dry preform is as close as possible to the final thickness of later component 68).

Therefore, a continuous compacting and stabilization particularly of braided components 68 by means of ultrasound is proposed.

One goal of the teaching described herein is to provide a possible method for compacting and stabilizing braided, wrapped, non-crimped, draped and preferably multilayer fiber profiles (carbon, aramid, glass fibers) that are supported by thermoplastic materials, in a continuous and automated process, in order to allow component 68 to be unmolded from molding tool 12 in a form that is close to the final contour. This is achieved by the thermal activation of thermoplastic binder material 20. A high heating rate using a discrete compression pressure is advantageous for this purpose.

The actual process of preform production has heretofore been regarded as discontinuous and non-automatable. Binder material 20 has previously been thermally activated in most cases using large air-circulating ovens, or via manual processes (e.g. the use of irons). Pre-compacting is achieved in such cases using a vacuum assembly, e.g. in a VAP process, in the oven, at a maximum of −1 bar vacuum pressure. In manual processes, the pressure on the heating element is regarded merely as a contribution to pre-compacting. The ultrasound method is already in use for welding plastics. However, this has heretofore been carried out in cycled processes. Initial attempts at using ultrasound compacting as a continuous process on flat, i.e. not three-dimensionally formed, woven fabrics or non-crimped fabrics have already been made, as described in US patent document US 2012/0085480 A1.

The oven process is discontinuous and non-automatable, involves high material expense, and does not permit compacting to the final thickness, necessitating an autoclaving process. Moreover, through heating is non-homogeneous, which can lead to damage to binder material 20. It is necessary to heat the core material, which is critical with varying thermal expansion and can lead to undulation. The oven process also involves a low process rate of approximately >2 h/component 68.

With manual processes, it is necessary to preform after each layer, which results in long process times. In this case as well, thorough heating can be achieved only non-homogeneously. The method cannot be automated.

The ultrasound that has previously been used could be applied only locally or at one position, and has been applied in cycles, i.e. discontinuously. An external anvil was also necessary, and only simple, flat structures could be produced.

Here, molding tool 12, which can comprise various materials (steel, aluminum, CFRP, wood . . . ), is used as an anvil, i.e. as pressure base 38, so that a multi-face, simultaneous compacting and stabilization is possible without an external anvil. The vibration generated between carbon fibers 18 results in rapid heating from the interior of component 68 outward, and does not result in any nominal heating of the core material (anvil). The use of pneumatic proportional valves 44, for example, allows a constant welding force to be applied and allows a homogeneous component thickness to the final dimension to be produced.

The selective use of sonotrode coatings 56 and/or concurrent buffer films 62 can prevent surface damage and misalignment of dry fibers 18.

By component 68 continuously “passing over” sonotrodes 14, the process time can be decreased significantly. The “one-shot” method advantageously enables a homogeneous and reproducible quality.

The open structure and the narrow sonotrode geometries allow complex and curved structures to be formed without loss of quality.

FIG. 1 schematically illustrates the structure of the functional units of the ultrasound preform system in an example in which a braiding core 11 is used as molding tool 12. The cross-sectional view in FIG. 2 shows the centrally guided molding tool 12, which acts as an anvil. The tool is spanned by a plurality of fiber layers 16, here in the form of braided layers, which comprise interlaminar binder materials 20. The ultrasound units 14 are pressed pneumatically with a constant welding force onto the braiding, and the resulting frictional heat activates the thermoplastic binder material 20, resulting in stabilization of the profile. As is clear from the side view of FIG. 3, continuity is integrated into the process by a constant feed rate, indicated by arrow 28. The surface of component 68 is protected from damage by a low-friction coating 56 on sonotrodes 14 or by a buffer film 62.

To preform a straight braiding core—as a simple case—the stabilization device 10 was configured according to FIG. 1 and a braiding core 11 as an anvil, made of aluminum in the present example and having a length of 2400 mm, was braided with a plurality of layers 16, e.g. four to six layers 16. In this case, the two opposite core faces 30 are consolidated simultaneously. For this purpose, the two functional units, i.e. sonotrodes 14, are aligned parallel to core faces 30, and braiding core 11 is guided continuously along between sonotrodes 14 by means of a robot 23 as feed device 23a. The necessary parameters (amplitude, welding force, feed) are controlled by means of control device 48 for controlling generator and pneumatics, in order to obtain the desired end result. The degree of compacting and the temperature that is applied can thereby be flexibly adjusted.

Additional cooling 46 at the sonotrodes 14 results in a rapid cooling and solidification of binder material 20.

FIGS. 6 to 10 show the consolidated material, which, as a result of the process, could be removed from core 11 without destruction of component 68. With an unconsolidated component 68, there would be no bonding between dry fibers 18, so that cutting away would result immediately in a destruction of the braiding.

To further enhance the technology, sonotrodes 14 may be mounted so as to float, allowing them to adjust independently to the contour of the core material. In this manner, highly complex and large structures can be preformed in an automated process.

Furthermore, specially formed radial sonotrodes 63 may be used as needed for continuous solidification in edge regions 63a.

The technology can be used for various core materials. These materials include soft materials, such as wood or CFRP, in addition to aluminum and steel, which are good oscillators. It is also conceivable to use the widest range of binder and fiber materials. The large process window permits a large number of conceivable combinations.

This technology may also be used for applying local fiber reinforcements (reinforcement patches 22) in an automated fashion or for applying and depositing braided layers 16 and/or lap layers (ply drop). A plurality of pre-stabilized preforms can also be connected to one another in this manner, for example.

The following advantages over known methods and devices are achieved:
very high process rate (>2 m/min);
high surface quality;
automatable, continuous process;
compacting to final thickness, i.e. high fiber volume, no autoclave required;
low material costs (no vacuum assembly);
low defect density;
flexibly adaptable to various materials;
lower energy costs;
homogeneous material behavior;
use for curved (complex) structures;
usable for related processes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 stabilization device
11 braiding core
12 molding tool
14 sonotrode
16 fiber layer
18 fiber
20 binder material
22 reinforcement patch
23 robot
23a feed device
24 consolidation device
26 oscillation
28 arrow
30 side face
32 pair
34 arrow
36 pressure application device
38 pressure base
40 pressure tool
42 pressure control device
44 proportional valve
46 cooling device
48 control device
56 coating
58 sonotrode surface
60 buffer film feed device
62 buffer film
63 radial sonotrode
63a edge region
64 flexible mount
66 surface structure
67 bearing surface
68 fiber composite components

What is claimed is:

1. A stabilization device, comprising:
a molding tool configured to receive a fiber layer having a binder material; and
a consolidation device having a sonotrode configured to apply ultrasonic energy to the fiber layer,
wherein the molding tool is configured to position the fiber layer in a predefined position relative to the sonotrode.

2. The stabilization device of claim 1, wherein the consolidation device has a pressure application device configured to apply pressure to the fiber layer.

3. The stabilization device of claim 2, wherein the pressure application device
comprises the molding tool that holds the fiber layer as a pressure base and the sonotrode as a pressure tool, or
has a pressure control device formed with proportional valves configured to press the sonotrode in a defined manner against the fiber layer.

4. The stabilization device of claim 1, further comprising:
a feed device configured to continuously move the molding tool and sonotrode relative to one another, or
a cooling device configured to cool the sonotrode.

5. The stabilization device of claim 1, wherein
the sonotrode is mounted so as to float, allowing it to adjust its position relative to a surface structure of the fiber layer,
the sonotrode has a low-friction coating on a sonotrode surface to be brought into contact with the fiber layer, or
the stabilization device further comprises a buffer film feed device configured to feed a buffer film between the fiber layer and the sonotrode.

6. The stabilization device of claim 1, wherein the sonotrode is a radial sonotrode configured to simultaneously encompass a side face and at least one edge region of the molding tool.

7. The stabilization device of claim 1, wherein the sonotrode comprises a first pair of sonotrodes arranged on opposite side faces of the molding tool and a second pair of sonotrodes arranged offset to the first pair of sonotrodes.

8. The stabilization device of claim 3, further comprising:
a control device configured to control the pressure control device, a feed device, or the sonotrode.

9. A stabilization method for stabilizing a fiber layer formed on a molding tool and having a binder material, comprising the following steps:
a) preparing a stabilization device comprising a sonotrode and a molding tool that holds the fiber layer;
b) moving the molding tool relative to the sonotrode; and
c) applying ultrasonic energy to the fiber layer.

10. The stabilization method of claim 9, wherein the sonotrode is pneumatically pressed against the fiber layer.

11. The stabilization method of claim 10, wherein
the sonotrode is provided with a low-friction coating before the sonotrode is pressed against the fiber layer, or
a buffer film is inserted between sonotrode and fiber layer.

12. The stabilization method of claim 9, further comprising:
cooling the sonotrode.

13. A method for producing fiber composite components having an open structure, comprising the following steps:
forming a fiber layer on a molding tool;
providing binder material in or on the fiber layer;
preparing a stabilization device comprising a sonotrode and the molding tool that holds the fiber layer;
moving the molding tool relative to the sonotrode; and
applying ultrasonic energy to the fiber layer.

14. The method of claim 13,
wherein the forming of the fiber layer on the molding tool comprises forming a plurality of fiber layers by
braiding fibers onto the molding tool;
applying reinforcement patches to a braided fiber layer; or
applying a fiber layer or a lap layer to the braided fiber layer; or
wherein the application of ultrasonic energy to the fiber layer forms a consolidated fiber layer, and after the ultrasonic energy is applied to the fiber layer the consolidated fiber layer is cut away from the molding tool.

15. The method of claim 13, wherein
the binder material is provided interlaminarly to the fibers that form the fiber layer, or
the binder material is applied to the fiber layer during formation of the fiber layer.
